(19) United States
(12) Patent Application Publication
(10) Pub. No.: US 2025/0161919 A1
(43) Pub. Date: May 22, 2025

(54) OXYGEN STORAGE MATERIAL

(71) Applicant: TOYOTA JIDOSHA KABUSHIKI KAISHA, Toyota-shi (JP)

(72) Inventors: Yoshio OHASHI, Gotemba-shi (JP); Naoto NAGATA, Gotemba-shi (JP)

(73) Assignee: TOYOTA JIDOSHA KABUSHIKI KAISHA, Toyota-shi (JP)

(21) Appl. No.: 18/945,703

(22) Filed: Nov. 13, 2024

(30) Foreign Application Priority Data
Nov. 22, 2023 (JP) 2023-198392
Apr. 5, 2024 (JP) 2024-061442

(51) Int. Cl. B01J 23/10; B01J 35/70

(52) U.S. Cl. CPC B01J 23/10; B01J 35/70; B01J 2235/15

(57) ABSTRACT

Provided is an inexpensive oxygen storage material having an excellent oxygen release performance at low temperature. The present disclosure relates to an oxygen storage material containing a composite oxide. The composite oxide contains cerium and/or europium and silicon and/or phosphorus. The composite oxide has an apatite-type crystalline structure.

### CROSS REFERENCE TO RELATED APPLICATIONS

The present application claims priority from Japanese patent application JP 2023-198392 filed on Nov. 22, 2023, the entire content of which is hereby incorporated by reference into this application. The present application claims priority from Japanese patent application JP 2024-061442 filed on Apr. 5, 2024, the entire content of which is hereby incorporated by reference into this application.

### BACKGROUND

### Technical Field

The present disclosure relates to an oxygen storage material.

### Background Art

An exhaust gas emitted from an internal combustion engine of an automobile and the like contains harmful components, such as carbon monoxide (CO), hydrocarbon (HC), and nitrogen oxide (NOx), and the harmful components are removed by an exhaust gas purification catalyst and then released into the atmosphere. Conventionally, a three-way catalyst that simultaneously oxidizes CO, HC and reduces NOx is used for the exhaust gas purification catalyst. As the three-way catalyst, a porous oxide carrier such as alumina (Al₂O₃), silica (SiO₂), zirconia (ZrO₂), and titania (TiO₂) on which noble metals such as platinum (Pt), palladium (Pd), and rhodium (Rh) are supported is widely used.

In recent years, an oxygen storage material, which is an inorganic material having an oxygen storage capacity (OSC performance), has been used for the exhaust gas purification catalyst in order to enhance an exhaust gas purification ability of the three-way catalyst in response to variations in oxygen concentration in the exhaust gas. Ceria (CeO₂) is known to have an excellent OSC performance and is widely used as an oxygen storage material in the form of ceria-zirconia composite oxide (CeO₂—ZrO₂).

As an oxygen storage material of such a ceria-zirconia composite oxide, for example, JP 2009-84061 A discloses a ceria-zirconia-based composite oxide containing a composite oxide of ceria and zirconia, in which a pyrochlore phase-type ordered array phase is formed by cerium ions and zirconium ions in the composite oxide, and 50% or more of the pyrochlore phase-type ordered array phase remains after heating in the atmosphere under a temperature condition of 1000° C. for 5 hours as compared with that before heating.

JP 2023-55681 A discloses a melilite-type oxide with an oxygen absorbing/releasing function. The oxide has a melilite-type structure, and has a composition represented by the general formula AₓB₂₋ₓCD₂E_{7+δ}, where A is cerium (Ce), B is one or two or more elements selected from the group consisting of an alkali metal element, an alkaline earth metal element, magnesium (Mg), indium (In), and a rare earth metal element (except for cerium), C and D are one or two or more elements selected from the group consisting of a transition metal element, a group 12 element, a group 13 element, a group 14 element, and a group 15 element, E is oxygen (O), x is 0 or more and 2.0 or less, and δ is −1.0 or more and 1.0 or less. The oxide retains electrical neutrality.

### SUMMARY

However, in the ceria-zirconia composite oxide in which the pyrochlore phase-type ordered array phase is formed as disclosed in JP 2009-84061 A, the use of zirconium (Zr), which is a rare metal, may increase the cost. Further, in the composite oxide, an activation energy for releasing excess oxygen from the crystalline structure is high, and there is a problem of a high temperature required for oxygen release.

On the other hand, the oxide having the melilite-type structure as disclosed in JP 2023-55681 A is made of calcium, aluminum, and the like, which are abundant elements. The oxide has many spaces in the crystalline structure into which excess oxygen can be incorporated, and the temperature required for oxygen release is low. However, in the oxide, the composition in which excess oxygen is incorporated into all of the spaces is unstable, resulting in a problem of a small oxygen storage amount.

Therefore, the present disclosure provides an inexpensive oxygen storage material having an excellent oxygen release performance at low temperature.

As a result of various examination of means to solve the above-described problems, the inventors have found that a composite oxide having an apatite-type crystalline structure containing Ce and/or europium (Eu) and silicon (Si) and/or phosphorus (P) has a smaller activation energy than Ce₂Zr₂O₇ having a pyrochlore-type crystalline structure containing Ce and Zr useful as a conventional oxygen storage material, and has an excellent oxygen storage property and oxygen release property at low temperature. Thus, the inventors achieved the present disclosure.

That is, the gist of the present disclosure is as follows.
(1) An oxygen storage material comprising a composite oxide, wherein the composite oxide contains cerium and/or europium and silicon and/or phosphorus, wherein the composite oxide has an apatite-type crystalline structure.
(2) The oxygen storage material according to (1), wherein the composite oxide is represented by the following general formula: A_{α}T_{β}X_{γ} (In the formula, A includes cerium (Ce) and/or europium (Eu); T includes silicon (Si) and/or phosphorus (P); X includes oxygen (O); α, β, and γ each represent a mole ratio; and α is 9.33 to 10, β is 6, and γ is 24 to 30.).
(3) The oxygen storage material according to (2), wherein A includes cerium.
(4) The oxygen storage material according to (2) or (3), wherein A includes europium.
(5) The oxygen storage material according to any one of (2) to (4), wherein a content of cerium and/or europium is 20 mol % or more relative to a total amount-of-substance of A.
(6) The oxygen storage material according to any one of (2) to (5), wherein A further includes one or more elements selected from the group consisting of an alkali metal, an alkaline earth metal, and a rare earth element other than cerium or europium.
(7) The oxygen storage material according to (6), wherein A further includes one or more elements selected from the group consisting of calcium (Ca), strontium (Sr), yttrium (Y), lanthanum (La), praseodymium (Pr), samarium (Sm), ytterbium (Yb), and lutetium (Lu).
(8) The oxygen storage material according to any one of (2) to (7), wherein T further includes one or more elements selected from the group consisting of a group 13 element, a group 14 element, and a group 15 element.
(9) The oxygen storage material according to (8), wherein T further includes boron (B).
(10) The oxygen storage material according to any one of (1) to (9), further comprising a catalyst metal, wherein the catalyst metal is supported on the composite oxide.
(11) The oxygen storage material according to (10), wherein a content of the catalyst metal is 0.01 weight % to 5 weight % relative to a total weight of the oxygen storage material.
(12) The oxygen storage material according to (10) or (11), wherein the catalyst metal contains a platinum group element.
(13) The oxygen storage material according to (12), wherein the platinum group element is one or more elements selected from the group consisting of rhodium (Rh), palladium (Pd), and platinum (Pt).
(14) An exhaust gas purification catalyst including the oxygen storage material according to any one of (1) to (13).
(15) A redox catalyst including the oxygen storage material according to any one of (1) to (13).
(16) A method for storing oxygen with the oxygen storage material according to any one of (1) to (13).
(17) A method for enriching oxygen with the oxygen storage material according to any one of (1) to (13).
(18) A method for removing oxygen with the oxygen storage material according to any one of (1) to (13).
(19) A method for heating/cooling with the oxygen storage material according to any one of (1) to (13).

The present disclosure provides an inexpensive oxygen storage material having an excellent oxygen release performance at low temperature.

### BRIEF DESCRIPTION OF THE DRAWINGS

FIG. 1 is a diagram schematically illustrating an apatite-type crystalline structure of an exemplary composite oxide included in the present disclosure;

FIG. 2 is an X-ray diffraction diagram of products of Example 1 and Comparative Examples 1 to 2;

FIG. 3A is an X-ray diffraction diagram of products of Examples 1 to 3 and Comparative Examples 3 to 8, and FIG. 3B is an X-ray diffraction diagram of products of Examples 4 to 12;

FIG. 4A shows measurement conditions for a hydrogen temperature-programmed reduction test, and FIG. 4B shows the H₂TPR results of the products of Example 1 and Comparative Examples 1 to 2 before and after Pd supporting;

FIG. 5 is a graph showing an oxygen release temperature and an oxygen storage amount of the products of Example 1 and Comparative Examples 1 to 2 after Pd supporting;

FIG. 6 is a graph showing an oxygen storage amount of products of Examples 1 to 12 and Comparative Examples 3 to 8;

FIG. 7 is an X-ray diffraction diagram of the product of Example 1 before and after oxidation;

FIG. 8 is an X-ray diffraction diagram of products of Examples 13 to 15;

FIG. 9 is a graph showing an oxygen storage amount of the products of Examples 1 to 2 and 13 to 15;

FIG. 10 is a diagram schematically illustrating an apatite-type crystalline structure of an exemplary composite oxide included in the present disclosure; and

FIG. 11 is a graph showing an oxygen storage amount of the products of Examples 9 to 10 and 13.

### DETAILED DESCRIPTION

The following describes some embodiments of the present disclosure in detail.

In the description, features of the present disclosure will be described with reference to the drawings as necessary. In the drawings, dimensions and shapes of respective components are exaggerated for clarification, and actual dimensions and shapes are not accurately illustrated. Accordingly, the technical scope of the present disclosure is not limited to the dimensions or the shapes of respective components illustrated in the drawings. An oxygen storage material of the present disclosure is not limited to the embodiments below, and can be performed in various configurations where changes, improvements, and the like which a person skilled in the art can make are given without departing from the gist of the present disclosure.

The present disclosure relates to an oxygen storage material containing a composite oxide. The composite oxide contains cerium and/or europium and silicon and/or phosphorus. The composite oxide has an apatite-type crystalline structure.

In the present disclosure, a crystalline structure of the composite oxide containing cerium and/or europium and silicon and/or phosphorus can be determined by an X-ray diffraction (XRD) analysis. In the present disclosure, the composite oxide containing cerium and/or europium and silicon and/or phosphorus has an apatite-type crystalline structure.

The basic XRD spectrum of the apatite-type crystalline structure is well known in the art. For example, when the composite oxide is Ce_{9.33}Si₆O₂₆, 2θ has peaks at four or more positions selected from the group consisting of 27.3°±0.5°, 28.2°±0.5°, 31.0°±0.5°, and 32.1°±0.5° in an XRD spectrum using copper Kα radiation.

It is a well-known fact in the art that the peak position of the basic XRD spectrum of the apatite-type crystalline structure changes based on the composition of the composite oxide.

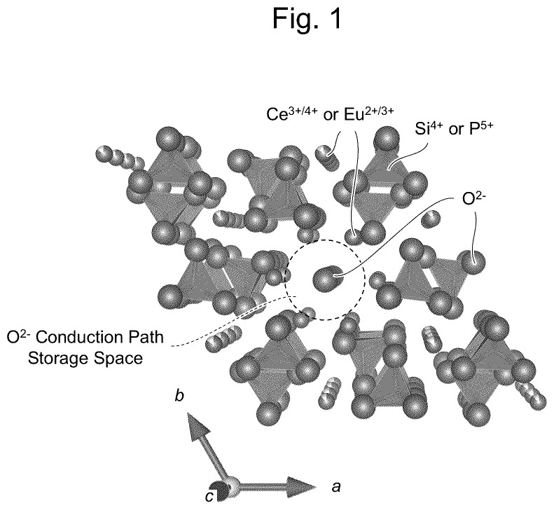

FIG. 1 schematically illustrates the apatite-type crystalline structure of an exemplary composite oxide included in the present disclosure. In the composite oxide containing cerium and/or europium and silicon and/or phosphorus of the present disclosure, the apatite-type crystalline structure has a structure in which a path through which oxide ions (O)²⁻) can conduct is surrounded by trivalent cerium ions (Ce³⁺) and/or divalent europium ions (Eu²⁺). The conduction path (storage space) of oxide ions is one-dimensional. Therefore, it is considered that the oxygen storage ability of the composite oxide of the present disclosure is provided when Ce³⁺ is oxidized to Ce⁴⁺ and Eu²⁺ is oxidized to Eu³⁺, cerium ions and/or europium ions are contracted in size, and at the same time, O²⁻ is introduced into the crystalline structure.

The composite oxide containing cerium and/or europium and silicon and/or phosphorus of the present disclosure can also be represented by the following formula:

A_{α}T_{β}X_{γ}

(In the formula, A includes cerium and/or europium; T includes silicon and/or phosphorus; X includes oxygen; α, β, and γ each represent a mole ratio; and α is 9.33 to 10.0, β is 6, and γ is 24 to 30.).

In one embodiment, A includes cerium. In one embodiment, A includes europium. In one embodiment, A includes cerium and europium.

In addition to Ce and/or Eu, A may further include one or more metal elements selected from the group consisting of an alkali metal, an alkaline earth metal, and a rare earth metal other than Ce or Eu. In one embodiment, A further includes, in addition to Ce and/or Eu, one or more metal elements selected from the group consisting of lithium (Li), sodium (Na), potassium (K), calcium (Ca), strontium (Sr), barium (Ba), yttrium (Y), lanthanum (La), praseodymium (Pr), samarium (Sm), terbium (Tb), ytterbium (Yb), and lutetium (Lu). In one embodiment, A further includes, in addition to Ce and/or Eu, one or more elements selected from the group consisting of Ca, Sr, Y, La, Pr, Sm, Yb, and Lu. In one embodiment, when A includes Ce, A further includes one or more elements selected from the group consisting of Ca, Sr, Y, La, Pr, Sm, Eu, Yb, and Lu. In one embodiment, when A includes Eu, A further includes one or more elements selected from the group consisting of Ce, La, and Pr.

The content of Ce in A is usually 20 mol % or more, 78 mol % or more in one embodiment, and 80 mol % or more in one embodiment, relative to the total amount-of-substance (mol) of A. The content of Ce in A may be 100 mol % relative to A (total mol).

The content of Eu in A is usually 20 mol % or more, 78 mol % or more in one embodiment, and 80 mol % or more in one embodiment, relative to the total amount-of-substance (mol) of A. The content of Eu in A may be 100 mol % relative to A (total mol).

The content of Ce and/or Eu in A within the above-described range can ensure a sufficient oxygen storage capacity.

The contents of elements other than Ce or Eu in A are not limited. The contents of elements other than Ce or Eu in A can be determined so as to compensate for charges of the contained Ce and/or Eu, as described in detail below.

T may further include, in addition to Si and/or P, one or more elements selected from the group consisting of a group 13 element, a group 14 element other than Si, and a group 15 element other than P. In one embodiment, T further includes, in addition to Si and/or P, one or more elements selected from the group consisting of boron (B), aluminum (Al), gallium (Ga), and germanium (Ge). In one embodiment, T further includes B in addition to Si and/or P.

The content of Si or P in T is usually 66 mol % or more, and 83 mol % or more in one embodiment, relative to the total amount-of-substance (mol) of T. The content of Si or P in T may be 100 mol % relative to T (total mol).

The content of Si or P in T within the above-described range can ensure a small cation (Si⁴⁺ or P⁵⁺) located in the center of a TO₄ tetrahedron, which is required to form the apatite-type structure.

The contents of elements other than Si or P in T can also be determined so as to compensate for charges of the contained Ce and/or Eu and Si and/or P, as described in detail below.

In the apatite-type crystalline structure of the composite oxide included in the present disclosure, Ce is contained as Ce³⁺, and Eu is contained as Eu²⁺. In the crystalline structure, Ce³⁺ and Eu²⁺ each have different valences, but occupy the same site. Thus, it is not possible to produce apatite by simply substituting Ce with Eu in a composite oxide. Therefore, when ions present in a composite oxide are changed to ions having a valence different from that of those ions, other ions present separately in the composite oxide, such as ions that do not contribute to the oxygen storage amount, that is, ions with a fixed valence, can also be changed in the same manner to perform charge compensation. For example, when substituting Ce³⁺ with Eu²⁺ in the composite oxide, this change in charge of −1 can be compensated for by a change in charge of +1 caused by, for example, a substitution of Ca²⁺ (Sr²⁺), which may occupy the same site as Ce and Eu, with La³⁺, and a substitution of Si⁴⁺, which may occupy a site different from that of Ce and Eu, with P⁵⁺. For example, when it is desired to determine a difference between the effects of Ce³⁺ and Eu²⁺ in the composite oxide, this can be performed by comparing Ce₈A₂T₆O₂₆ (A=Ca or Sr, T=Si) with Eu₈A₂T₆O₂₆ (A=La, T=P).

Further, in the apatite-type crystalline structure of the composite oxide included in the present disclosure, when Ce³⁺ in the composite oxide Ce₈A₂T₆O₂₆ (A=Ca or Sr, T=Si) is substituted with Eu²⁺, Eu₈A₂T₆O₂₆ (A=Ce, T=P) can also be produced by charge compensation by changing Ca or Sr of A to Ce and by substituting Si⁴⁺ with P⁵⁺.

X includes O, and is usually made of O. In X, O may optionally be present in the form of OH.

The content of O in X is usually 92 mol % or more, and 99 mol % or more in one embodiment, relative to the total amount-of-substance (mol) of X. The content of O in X may be 100 mol % relative to X (total mol).

The content of O in X within the above-described range can ensure a sufficient oxygen storage capacity.

In one embodiment, the composite oxide containing cerium and silicon or phosphorus of the present disclosure is represented by the following formula:

(Ce,A′)_{α}(Si,P,T′)_{β}O_{γ}

(In the formula, A′ is one or more metal elements selected from the group consisting of Ca, Sr, Y, La, Pr, Sm, Eu, Yb, and Lu; T′ is B; α, β, and γ each represent a mole ratio; and α is 9.33 to 10, β is 6, and γ is 24 to 30.). Here, the mole ratio of Ce to A′ (Ce:A′) is usually 1:0 to 1:4, and the mole ratio of Si or P to T′ (Si, P:T′) is usually 1:0 to 5:1.

In one embodiment, the composite oxide containing cerium and silicon or phosphorus of the present disclosure is represented by Ce_{9.33}Si₆O₂₆, Ce₂Ca₈P₆O₂₆, Ce_{9.33}Si₅BO_{25.5}, Ce_{7.33} Y₂Si₆O₂₆, Ce_{7.33}La₂Si₆O₂₆, Ce_{7.33}Pr₂Si₆O₂₆, Ce_{7.33}Sm₂Si₆O₂₆, Ce_{7.33}Lu₂Si₆O₂₆, Ce₈Ca₂Si₆O₂₆, Ce₈Sr₂Si₆O₂₆, Ce₈Eu₂Si₆O₂₆, or Ce₈Yb₂Si₆O₂₆.

In one embodiment, the composite oxide containing europium and phosphorus of the present disclosure is represented by the following formula:

(Eu,A′)_{α}(P)_{β}O_{γ}

(In the formula, A′ is one or more metal elements selected from the group consisting of Ce, La, and Pr; α, β, and γ each represent a mole ratio; and α is 9.33 to 10, β is 6, and γ is 24 to 30.).

In one embodiment, the composite oxide containing europium and phosphorus of the present disclosure is represented by Eu₈Ce₂P₆O₂₆, Eu₈La₂P₆O₂₆, or Eu₈La₂P₆O₂₆.

The oxygen storage material of the present disclosure may further contain a catalyst metal. The catalyst metal is supported on the composite oxide described above. The catalyst metal includes a noble metal. The noble metal includes, but is not limited to, a platinum group noble metal. The platinum group noble metal includes ruthenium (Ru), rhodium (Rh), palladium (Pd), osmium (Os), iridium (Ir), and platinum (Pt). In one embodiment, the noble metal is one or more selected from the group consisting of Rh, Pt, and Pd. A support amount of the noble metal is similar to that of the conventional exhaust gas purification catalyst and is, but not limited to, 0.01 weight % to 5 weight %, and 0.5 weight % to 2 weight % in one embodiment, relative to the total weight of the oxygen storage material.

The oxygen storage material of the present disclosure is excellent in an oxygen release at low temperature. Therefore, the present disclosure also relates to an exhaust gas purification catalyst and/or a redox catalyst containing the oxygen storage material of the present disclosure.

The exhaust gas purification catalyst and/or the redox catalyst of the present disclosure may contain a carrier material other than the oxygen storage material of the present disclosure. The carrier material other than the oxygen storage material of the present disclosure includes a metal oxide that is porous and has an excellent heat resistance. For example, an aluminum oxide (alumina: Al₂O₃), a zirconium oxide (zirconia: ZrO₂), a silicon oxide (silica: SiO₂), a composite oxide containing these metal oxides as a main component, or the like can be used. In the exhaust gas purification catalyst, a supporting method may be a conventional supporting method, such as an adsorption supporting method or a water-absorption supporting method.

The exhaust gas purification catalyst and/or redox catalyst of the present disclosure can exhibit an excellent ordered structure durability and OSC performance over a wide temperature range. The exhaust gas purification catalyst of the present disclosure is usually used in a low temperature range of about 200° C. to 600° C.

Further, by utilizing the property of absorbing and releasing oxygen and the property of having different energy states in the state of adsorbing oxygen and the state of releasing oxygen of the oxygen storage material of the present disclosure, the use of the oxygen storage material of the present disclosure allows storing oxygen (oxygen storage method), enriching oxygen (oxygen enrichment method), removing oxygen (oxygen removal method), and/or heating and/or cooling (heating/cooling method).

The oxygen storage material of the present disclosure can be produced by an ordinary method, such as a solid phase method, a liquid phase method, or an alkoxide method. For example, the oxygen storage material is produced by mixing an aqueous solution of a cerium compound, an europium compound, a silicon compound, a phosphorus compound, and optionally a compound containing an element other than Ce, Eu, Si or P as described above (hereinafter, also referred to as “cerium compound, silicon compound, and the like”) and an aqueous solution of a complexing agent, and drying the mixture to deposit a product containing Ce and/or Eu and Si and/or P, and then firing the product in a reducing atmosphere. The cerium compound, the silicon compound, and the like can also be used as a solution of a non-aqueous solvent, such as alcohol or organic carboxylic acid ester.

As the cerium compound, for example, water-soluble compounds including nitrates such as cerium nitrate and diammonium cerium nitrate, sulfates such as ceric sulfate, and chlorides such as cerium chloride, and alcohol-soluble compounds including alkoxides such as cerium isopropoxide can be used.

As the europium compound, for example, water-soluble compounds including nitrates such as europium nitrate, sulfates such as europium sulfate, and chlorides such as europium chloride, and alcohol-soluble compounds including alkoxides such as europium isopropoxide can be used.

As the silicon compound, alkoxides such as tetraethyl orthosilicate, tetraisopropyl orthosilicate, and the like can be used.

As the phosphorus compound, ammonium dihydrogenphosphate and the like can be used.

As the compound containing elements other than Ce or Si, water-soluble or alcohol-soluble compounds such as nitrate, sulfate, chloride, or alkoxide can be used.

Examples of the complexing agent include, but are not particularly limited to, polycarboxylic acids, amino acids, and the like. Examples of the polycarboxylic acid include oxalic acid, malonic acid, succinic acid, glutaric acid, adipic acid, maleic acid, citric acid, tartaric acid, and the like. In one embodiment, the complexing agent is citric acid. Examples of the amino acid include glycine, alanine, asparagine, aspartic acid, and the like.

If a precipitate is formed by mixing the aqueous solution of the cerium compound, the silicon compound, and the like with the aqueous solution of the complexing agent, drying may be performed after filtering the precipitate.

The drying of the mixed solution of the aqueous solution of the cerium compound, the silicon compound, and the like and the aqueous solution of the complexing agent can be performed usually at 50° C. to 150° C., usually for 5 hours to 48 hours.

The firing of the product containing Ce and/or Eu and Si and/or P can usually be performed by heating and holding the product at 600° C. to 1500° C. for 2 hours to 48 hours in a reducing atmosphere. The reducing atmosphere can be an inert gas atmosphere or a non-oxidizing atmosphere, and can be an atmosphere containing a reducing gas such as H₂, CO, and the like in one embodiment. Thus, the apatite-type oxygen storage material is obtained.

### EXAMPLES

While the following describes some Examples regarding the present disclosure, it is not intended to limit the present disclosure to those described in such Examples.

### 1. Production of Oxygen Storage Material

### 1-1. Reagent

Cerium (III) nitrate hexahydrate (Ce(NO₃)₃·6H₂O) (manufactured by Nacalai Tesque, INC.): ≥35.0 weight % (as CeO₂)
Ammonium cerium (IV) nitrate (NH₄)₂Ce(NO₃)₆ (manufactured by Tokyo Chemical Industry Co., Ltd.): >98.0 weight %
Yttrium (III) nitrate hexahydrate (Y(NO₃)₃·6H₂O) (manufactured by Kanto Chemical Co., Inc.): >99.99 weight %
Lanthanum (III) nitrate hexahydrate (La(NO₃)₃·6H₂O) (manufactured by Nacalai Tesque, INC.): ≥99.9 weight %
Praseodymium (III) nitrate hexahydrate (Pr(NO₃)₃·6H₂O) (manufactured by Kanto Chemical Co., Inc.): >99.95 weight %
Neodymium (III) nitrate hexahydrate (Nd(NO₃)₃·6H₂O) (manufactured by FUJIFILM Wako Pure Chemical Corporation): 99.5 weight %
Samarium (III) nitrate hexahydrate (Sm(NO₃)₃·6H₂O) (manufactured by FUJIFILM Wako Pure Chemical Corporation): 99.5 weight %
Europium (III) nitrate hexahydrate (Eu(NO₃)₃·6H₂O) (manufactured by Kanto Chemical Co., Inc.): >99.95 weight %
Gadolinium (III) nitrate hexahydrate (Gd(NO₃)₃·6H₂O) (manufactured by FUJIFILM Wako Pure Chemical Corporation): 99.5 weight %
Terbium (III) nitrate hexahydrate (Tb(NO₃)₃·6H₂O) (manufactured by Kanto Chemical Co., Inc.): >99.95 weight %
Ytterbium (III) nitrate pentahydrate (Yb(NO₃)₃·5H₂O) (manufactured by Sigma-Aldrich): 99.9%
Lutetium (III) nitrate tetrahydrate (Lu(NO₃)₃·4H₂O) (manufactured by Kanto Chemical Co., Inc.): >99.95 weight %
Calcium nitrate tetrahydrate (Ca(NO₃)₂·4H₂O) (manufactured by FUJIFILM Wako Pure Chemical Corporation): 98.5+ weight %
Strontium nitrate (Sr(NO₃)₂) (manufactured by FUJIFILM Wako Pure Chemical Corporation): 98.0 to 102.0 weight %
Tetraethyl orthosilicate (Si(OEt)₄) (manufactured by Tokyo Chemical Industry Co., Ltd.): >98.0 weight %
Ammonium dihydrogenphosphate ((NH₄)H₂PO₄) (manufactured by FUJIFILM Wako Pure Chemical Corporation): 99.0+ weight %
Boric acid (H₃BO₃) (manufactured by FUJIFILM Wako Pure Chemical Corporation): 99.5+ weight %
Aluminum nitrate nonahydrate (Al(NO₃)₃·9H₂O) (manufactured by FUJIFILM Wako Pure Chemical Corporation): 98.0+ weight %
Zirconium nitrate oxide dihydrate (ZrO(NO₃)₂·2H₂O) (manufactured by Kanto Chemical Co., Inc.): >99.0 weight %
Citric acid (manufactured by FUJIFILM Wako Pure Chemical Corporation): 98.0+ weight %
Ethylene glycol (manufactured by Nacalai Tesque, INC.): 99.5 weight %
Palladium (II) nitrate (Pd(NO₃)₂) (manufactured by FUJIFILM Wako Pure Chemical Corporation): 97.0+ weight %
Palladium (II) acetate (Pd(OAc)₂) (manufactured by FUJIFILM Wako Pure Chemical Corporation): 97.0+ weight %

### 1-2. Production of Composite Oxide

### Example 1 (Ce_{9.33}Si₆O₂₆)

(1) A stirrer was put in a 500 mL glass beaker, and Ce(NO₃)₃·6H₂O (6.61 g, 15.2 mmol) and Si(OEt)₄ (2.04 g, 9.78 mmol) as raw materials, citric acid (19.2 g, 100 mmol) and ethylene glycol (6.21 g, 100 mmol) as additives, and distilled water (18 mL) and ethanol (200 mL) as solvents were added.
(2) The solution was heated while being stirred using a hot stirrer, and evaporated to dryness.
(3) The contents were collected, the stirrer was removed, and the contents were pulverized and mixed in a mortar.
(4) The powder was transferred to an alumina crucible and calcined in the atmosphere at 500° C. for 6 hours using a muffle furnace.
(5) The powder was transferred to an alumina boat, loaded with an activated carbon, and fired at 1200° C. for 16 hours under an Ar flow at 0.5 L/minute.
(6) The activated carbon was removed from the alumina boat and the product was collected.

### Comparative Example 1 (CeCaAl₃O₇)

(1) A stirrer was put in a 500 mL glass beaker, and (NH₄)₂Ce(NO₃)₆ (2.74 g, 5.00 mmol), Ca(NO₃)₂·4H₂O (1.18 g, 5.00 mmol), and Al(NO₃)₃·9H₂O (5.63 g, 15.0 mmol) as raw materials, citric acid (9.6 g, 100 mmol) as an additive, and distilled water (100 mL) as a solvent were added.
(2) The solution was heated while being stirred using a hot stirrer, and evaporated to dryness.
(3) The contents were collected, the stirrer was removed, and the contents were pulverized and mixed in a mortar.
(4) The powder was transferred to an alumina boat and fired at 1000° C. for 16 hours under a 10% H₂/Ar flow at 5 L/minute to collect the product.

### Comparative Example 2 (Ce₂Zr₂O₇)

(1) A stirrer was put in a 1 L glass beaker, and Ce(NO₃)₃·6H₂O (8.68 g, 20.0 mmol) and ZrO(NO₃)₂·6H₂O (5.35 g, 20.0 mmol) as raw materials, and distilled water (100 mL) as a solvent were added, stirred and dissolved.
(2)₂₈% ammonia water (32 mL) was diluted with distilled water (900 mL), the solution of (1) was added, and stirring was continued for a whole day and night at room temperature.
(3) The obtained solution and precipitate were transferred to a centrifuge tube and centrifuged at 3,000 rpm for 5 minutes, and a supernatant was removed.
(4) Distilled water (500 mL) was added to the obtained precipitate to redisperse the precipitate, and the precipitate was centrifuged. This operation was repeated twice to wash the precipitate.
(5) The obtained precipitate was calcined at 250° C. for 2 hours, and pulverized in a mortar.
(6) The obtained powder was fired at 800° C. for 5 hours, and the obtained powder was subjected to compression molding at 2 t.
(7) The molded body was fired at 1400° C. for 5 hours under a 10% H₂/N₂ flow at 5 L/minute to collect the product.

### Comparative Example 3 (La_{9.33}Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to La(NO₃)₃·6H₂O (6.59 g, 15.2 mmol) and Si(OEt)₄ (2.04 g, 9.78 mmol).

### Comparative Example 4 (Pr_{9.33}Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Pr(NO₃)₃·6H₂O (6.62 g, 15.2 mmol) and Si(OEt)₄ (2.04 g, 9.78 mmol).

### Comparative Example 5 (Nd_{9.33}Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Nd(NO₃)₃·6H₂O (6.67 g, 15.2 mmol) and Si(OEt)₄ (2.04 g, 9.78 mmol).

### Comparative Example 6 (Sm_{9.33}Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Sm(NO₃)₃·6H₂O (6.76 g, 15.2 mmol) and Si(OEt)₄ (2.04 g, 9.78 mmol).

### Comparative Example 7 (Gd_{9.33}Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Gd(NO₃)₃·6H₂O (6.87 g, 15.2 mmol) and Si(OEt)₄ (2.04 g, 9.78 mmol).

### Comparative Example 8 (Tb_{9.33}Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Tb(NO₃)₃·6H₂O (6.89 g, 15.2 mmol) and Si(OEt)₄ (2.04 g, 9.78 mmol).

### Example 2 (Ce₂Ca₈P₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Ce(NO₃)₃·6H₂O (1.36 g, 3.12 mmol), Ca(NO₃)₃·4H₂O (2.95 g, 12.5 mmol), and (NH₄)H₂PO₄ (1.08 g, 9.38 mmol).

### Example 3 (Ce_{9.33}Si₅BO_{25.5})

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Ce(NO₃)₃·6H₂O (6.61 g, 15.2 mmol), Si(OEt)₄ (1.70 g, 8.15 mmol), and H₃BO₃ (0.101 g, 1.63 mmol).

### Example 4 (Ce_{7.33} Y₂Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Ce(NO₃)₃·6H₂O (5.19 g, 12.0 mmol), Y(NO₃)₃·6H₂O (1.24 g, 3.26 mmol), and Si(OEt)₄ (2.04 g, 9.78 mmol).

### Example 5 (Ce_{7.33}La₂Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Ce(NO₃)₃·6H₂O (5.19 g, 12.0 mmol), La(NO₃)₃·6H₂O (1.41 g, 3.26 mmol), and Si(OEt)₄ (2.04 g, 9.78 mmol).

### Example 6 (Ce_{7.33}Pr₂Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Ce(NO₃)₃·6H₂O (5.19 g, 12.0 mmol), Pr(NO₃)₃·6H₂O (1.42 g, 3.26 mmol), and Si(OEt)₄ (2.04 g, 9.78 mmol).

### Example 7 (Ce_{7.33}Sm₂Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Ce(NO₃)₃·6H₂O (5.19 g, 12.0 mmol), Sm(NO₃)₃·6H₂O (1.45 g, 3.26 mmol), and Si(OEt)₄ (2.04 g, 9.78 mmol).

### Example 8 (Ce_{7.33}Lu₂Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Ce(NO₃)₃·6H₂O (5.19 g, 12.0 mmol), Lu(NO₃)₃·4H₂O (1.41 g, 3.26 mmol), and Si(OEt)₄ (2.04 g, 9.78 mmol).

### Example 9 (Ce₈Ca₂Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Ce(NO₃)₃·6H₂O (5.43 g, 12.5 mmol), Ca(NO₃)₂·4H₂O (0.738 g, 3.12 mmol), and Si(OEt)₄ (1.95 g, 9.38 mmol).

### Example 10 (Ce₈Sr₂Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Ce(NO₃)₃·6H₂O (5.43 g, 12.5 mmol), Sr(NO₃)₂ (0.661 g, 3.12 mmol), and Si(OEt)₄ (1.95 g, 9.38 mmol).

### Example 11 (Ce₈Eu₂Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Ce(NO₃)₃·6H₂O (5.43 g, 12.5 mmol), Eu(NO₃)₃·6H₂O (1.39 g, 3.12 mmol), and Si(OEt)₄ (1.95 g, 9.38 mmol).

### Example 12 (Ce₈Yb₂Si₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Ce(NO₃)₃·6H₂O (5.43 g, 12.5 mmol), Yb(NO₃)₃·5H₂O (1.40 g, 3.12 mmol), and Si(OEt)₄ (1.95 g, 9.38 mmol).

### Example 13 (Eu₈La₂P₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Eu(NO₃)₃·6H₂O (5.58 g, 12.5 mmol), La(NO₃)₃·6H₂O (1.35 g, 3.12 mmol), and (NH₄)H₂PO₄ (1.08 g, 9.38 mmol).

### Example 14 (Eu₈Ce₂P₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Eu(NO₃)₃·6H₂O (5.58 g, 12.5 mmol), Ce(NO₃)₃·6H₂O (1.36 g, 3.12 mmol), and (NH₄)H₂PO₄ (1.08 g, 9.38 mmol).

### Example 15 (Eu₈Pr₂P₆O₂₆)

The product was collected similarly to Example 1, except that Ce(NO₃)₃·6H₂O (6.61 g, 15.2 mmol) and Si(OEt)₄ (2.04 g, 9.78 mmol) as raw materials in Example 1 were changed to Eu(NO₃)₃·6H₂O (5.58 g, 12.5 mmol), Pr(NO₃)₃·6H₂O (1.36 g, 3.12 mmol), and (NH₄)H₂PO₄ (1.08 g, 9.38 mmol).

### 2. Analysis and Evaluation of Product

### 2-1. X-ray Diffraction Measurement (Confirmation of Crystalline Structure of Product)

An X-ray diffraction (XRD) measurement was performed on each of the products of Examples 1 to 15 and Comparative Examples 1 to 8. The measurement device and the measurement condition are described below.
Measurement device: RINT RAPID II (manufactured by Rigaku Corporation)
Measuring condition: Voltage 50 V, current 100 mA, collimator diameter φ0.3 mm, sample angle ω15°
   2-2. Apatite-type Ce_{9.33}Si₆O₂₆, Mellite-type CeCaAl₃O₇, and Pyrochlore-type Ce₂Zr₂O₇

The X-ray diffraction diagrams predicted from the crystalline structure were calculated and compared with the X-ray diffraction diagrams of the respective products.

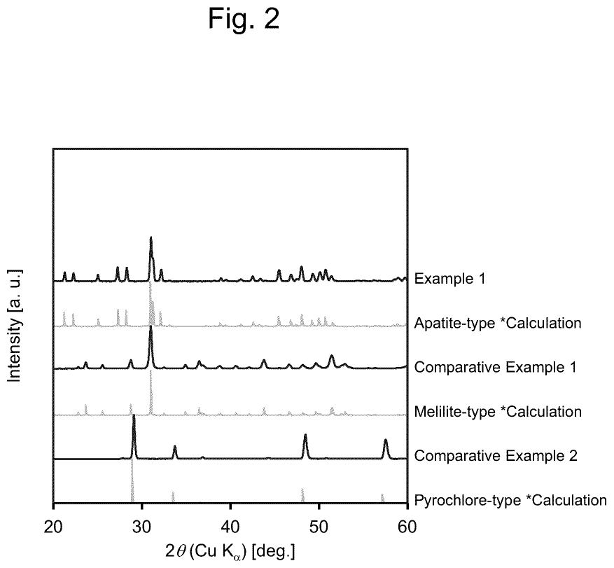

FIG. 2 shows the X-ray diffraction diagram of the products of Example 1 and Comparative Examples 1 to 2. From FIG. 2, it was found that the product of Example 1 had an apatite-type crystalline structure, the product of Comparative Example 1 had a mellite-type crystalline structure, and the product of Comparative Example 2 had a pyrochlore-type crystalline structure.

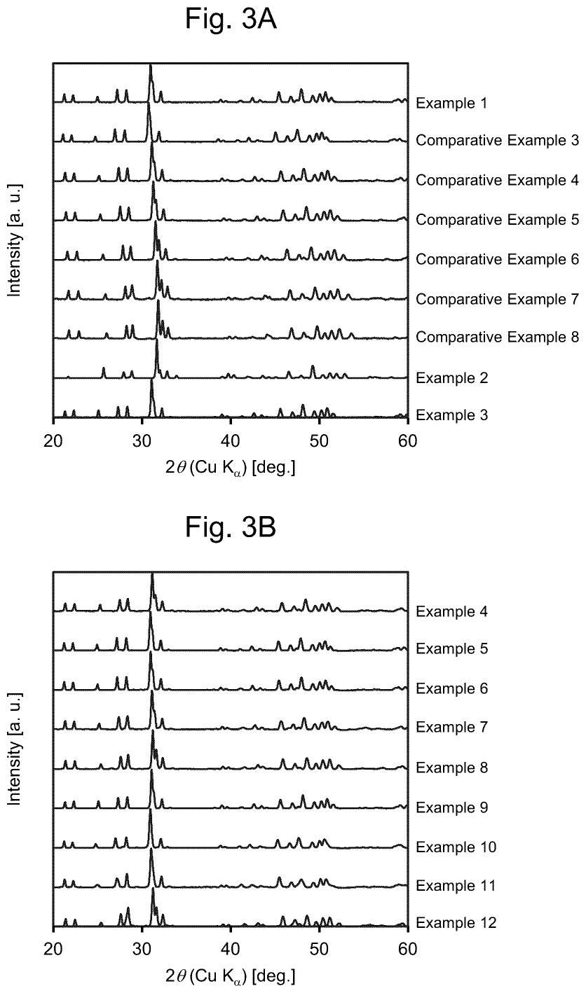

FIG. 3A shows the X-ray diffraction diagram of the products of Examples 1 to 3 and Comparative Examples 3 to 8, and FIG. 3B shows the X-ray diffraction diagram of the products of Examples 4 to 12. From FIGS. 3A and 3B, it was found that the products of Examples 1 to 12 and Comparative Examples 3 to 8 had the apatite-type crystalline structure.

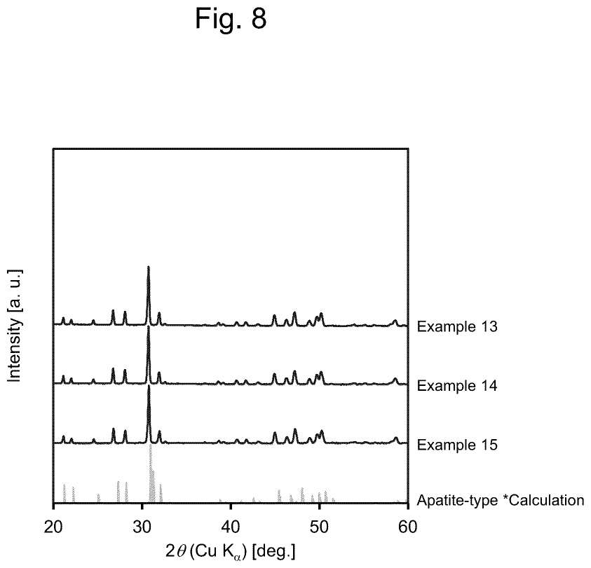

FIG. 8 shows the X-ray diffraction diagram of the products of Examples 13 to 15. From FIG. 8, it was found that the products of Examples 13 to 15 had the apatite-type crystalline structure.

2-3. Confirmation of Oxygen Desorption Temperature under Reducing Atmosphere (Confirmation of Oxygen Storage Ability of Product Containing Ce)

The products of Example 1 and Comparative Examples 1 to 2 were each subjected to a hydrogen temperature-programmed reduction (H₂TPR). The measurement device is described below.
Measurement device: BELCAT A (manufactured by MicrotracBEL Corp.)

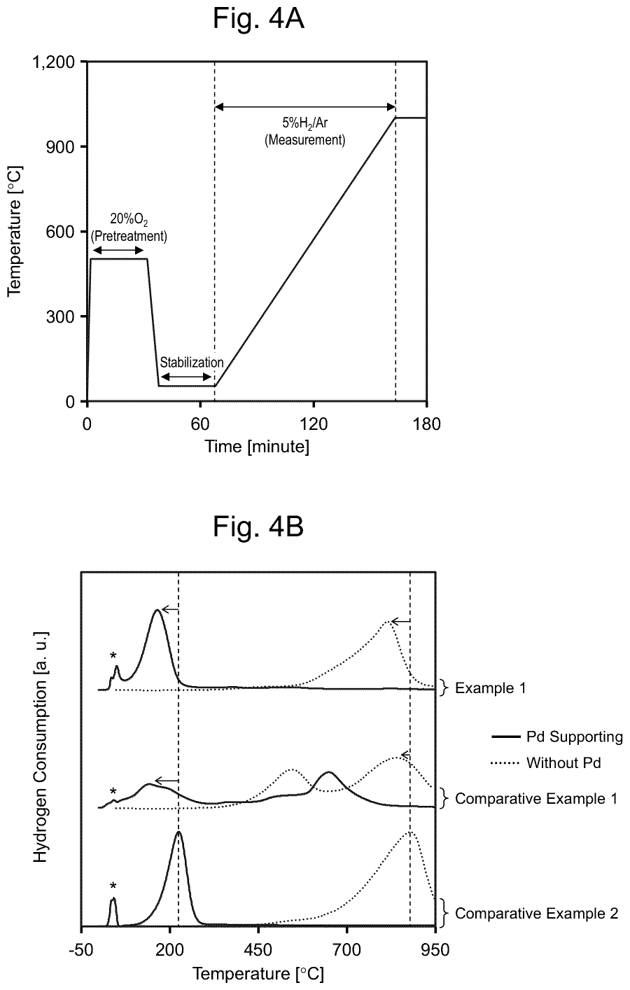

The measurement conditions are shown in FIG. 4A and the following.
Pretreatment condition: The product (about 50 mg) was introduced into a sample tube, and then the temperature was increased to 500° C. under a 20% O₂/He flow at 30 mL/minute. After the pretreatment for 10 minutes, the product was cooled.
Measurement condition: After replacing with Ar, the temperature was increased while heating at 10° C./minute under a 5% H₂/Ar flow at 30 mL/minute, and hydrogen (H₂) consumption was analyzed. The analysis was performed with a TCD, and desiccant was placed on the front stage of the TCD to trap the generated water.

The products of Example 1 and Comparative Examples 1 to 2 on which Pd is supported were also subjected to H₂TPR. The Pd supporting condition is described below.
Pd supporting condition (Example 1 and Comparative Example 2): 30 mL of distilled water was put in a 100 ml beaker, and Pd(NO₃)₂ was added such that Pd was 1 weight % relative to the product, stirred and dissolved at room temperature, and then heated after the product was added, and evaporated to dryness. The obtained solid was dried at 120° C. overnight, and then pulverized in a mortar, and fired at 500° C. for 3 hours to obtain a product supporting Pd.
Pd supporting condition (Comparative Example 1): The product supporting Pd was obtained under similar conditions to the Pd supporting condition (Example 1 and Comparative Example 2), except that, in the Pd supporting condition (Example 1 and Comparative Example 2), 30 mL of distilled water was changed to 30 mL of acetone and Pd(NO₃)₂ was changed to Pd(OAc)₂.

FIG. 4B shows the H₂TPR results of the products of Example 1 and Comparative Examples 1 to 2 before and after Pd supporting. The peaks (*) appearing at low temperatures in the products after Pd supporting in FIG. 4B are considered to be due to the reduction of the supported Pd. It was found that, in the products not supporting Pd, peaks of hydrogen consumption appeared at a lower temperature and oxygen was released at a lower temperature in Example 1 and Comparative Example 1 than in Comparative Example 2. In Comparative Example 1, two peaks have appeared. It was found that while supporting Pd caused the peaks of hydrogen consumption to shift to the lower-temperature side in any of the products, the peaks of hydrogen consumption still appeared on the lower-temperature side and oxygen was released at a lower temperature in Example 1 and Comparative Example 1 than in Comparative Example 2.

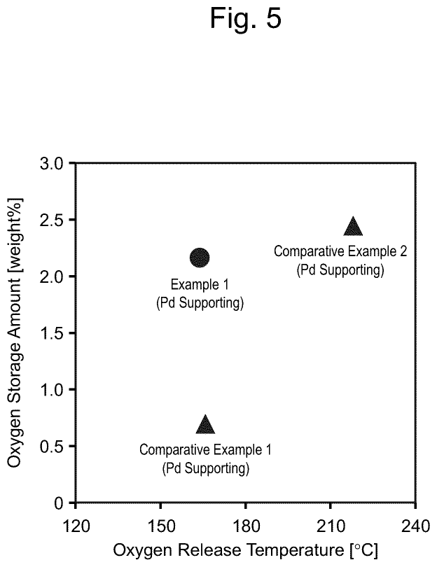

Subsequently, for the H₂TPR results of the products of Example 1 and Comparative Examples 1 to 2 after Pd supporting, since the large hydrogen consumption peaks at 150° C. to 250° C. are considered to be due to oxygen release of the oxygen storage material, the position of the hydrogen consumption peak was taken as an oxygen release temperature and an oxygen storage amount was determined from the total hydrogen consumption excluding Pd-derived hydrogen consumption. FIG. 5 shows the oxygen release temperature and the oxygen storage amount of the products of Example 1 and Comparative Examples 1 to 2 after Pd supporting.

From FIG. 5, it was found that the product of Example 1 had approximately the same oxygen storage amount as that of Comparative Example 2, while also having a property of releasing oxygen at a temperature as low as that of Comparative Example 1.

2-4. Confirmation of Weight Change in Oxidizing Atmosphere (Confirmation of Oxygen Storage Ability of Product having Apatite-type Crystalline Structure)

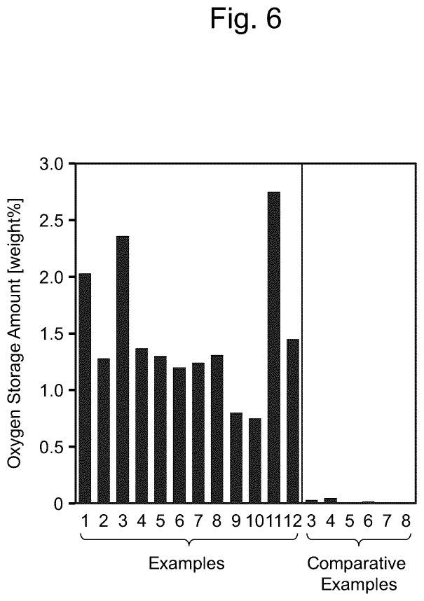

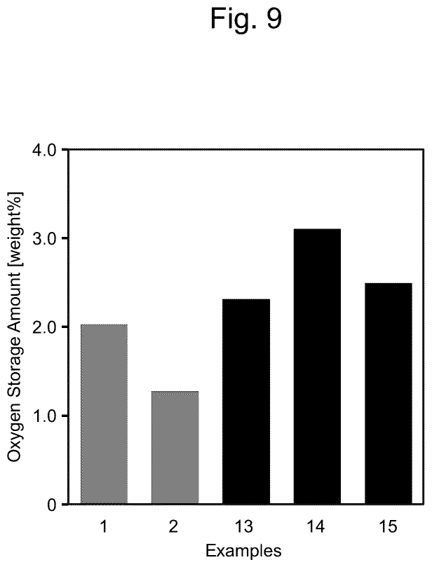

The products of Examples 1 to 15 and Comparative Examples 3 to 8 were oxidized in the atmosphere at 500° C. for 2 hours, and the oxygen storage amount was determined from the weight change (OSC=((weight after oxidation− weight before oxidation)/weight before oxidation)×100). FIG. 6 shows the oxygen storage amount of the products of Examples 1 to 12 and Comparative Examples 3 to 8. FIG. 9 shows the oxygen storage amount of the products of Examples 1, 2, and 13 to 15. Tables 1 lists the composition, the crystalline structure, the H₂TPR (Pd supporting), and the oxygen storage amount by atmospheric oxidation of the composite oxides of Examples 1 to 15 and Comparative Examples 1 to 8.

TABLE 1
Composition, Crystalline Structure, and Oxygen Storage
Capacity of Examples and Comparative Examples

| | | | H₂TPR | | Atmospheric |
|---|---|---|---|---|---|
| | | | (Pd Supporting) | | Oxidation |
| | | Crystalline | Desorption | OSC | OSC |
| Example | Composition | Structure | Temperature [° C.] | [weight %] | [weight)%] |
| Comparative Example 1 | CeCaAl₃O₇ | Melilite | 166 | 0.70 | — |
| Comparative Example 2 | Ce₂Zr₂O₇ | Pyroch [symbol] ore | 218 | 2.44 | — |
| Example 1 | Ce_{9.33}Si [symbol] O₂₆ | Apatite | 184 | 2.18 | 2.03 |
| Comparative Example 3 | La_{9.33}Si [symbol] O₂₆ | Apatite | — | — | 0.03 |
| Comparative Example 4 | Pr_{9.33}Si [symbol] O₂₆ | Apatite | — | — | 0.05 |
| Comparative Example 5 | Nd_{9.33}Si [symbol] O₂₆ | Apatite | — | — | 0.00 |
| Comparative Example 6 | Sm_{9.33}Si [symbol] O₂₆ | Apatite | — | — | 0.02 |
| Comparative Example 7 | Gd_{9.33}Si [symbol] O₂₆ | Apatite | — | — | 0.00 |
| Comparative Example 8 | Tb_{9.33}Si [symbol] O₂₆ | Apatite | — | — | 0.00 |
| Example 2 | Ce₂Ca₈P [symbol] O₂₆ | Apatite | — | — | 1.28 |
| Example 3 | Ce_{9.33}Si₅BO_{25.5} | Apatite | — | — | 2.36 |
| Example 4 | Ce_{7.33}Y₂Si [symbol] O₂₆ | Apatite | — | — | 1.37 |
| Example 5 | Ce_{7.33}La₂Si [symbol] O₂₆ | Apatite | — | — | 1.03 |
| Example 6 | Ce_{7.33}Pr₂Si₆O₂₆ | Apatite | — | — | 1.20 |
| Example 7 | Ce_{7.33}Sm₂Si₆O₂₆ | Apatite | — | — | 1.24 |
| Example 8 | Ce_{7.33}Lu₂Si₆O₂₆ | Apatite | — | — | 1.31 |
| Example 9 | Ce [symbol] Ca₂Si₆O₂₆ | Apatite | — | — | 0.80 |
| Example 10 | Ce [symbol] Sr₂Si₆O₂₆ | Apatite | — | — | 0.75 |
| Example 11 | Ce₅Eu₂Si₆O₂₆ | Apatite | — | — | 2.75 |
| Example 12 | Ce [symbol] Yb₂Si₆O₂₆ | Apatite | — | — | 1.45 |
| Example 13 | Eu [symbol] La₂P [symbol] O₂₆ | Apatite | — | — | 2.31 |
| Example 14 | Eu [symbol] Ce₂P₆O₂₆ | Apatite | — | — | 3.10 |
| Example 15 | Eu [symbol] Pr₂P₆O₂₆ | Apatite | — | — | 2.49 |

[symbol]

indicates data missing or illegible when filed

From FIG. 6 and Table 1, it was confirmed that the products of Examples 1 to 12 containing Ce showed a significant weight change due to oxidation and had an oxygen storage ability. The products of Comparative Examples 3 to 8 containing rare earth elements other than Ce showed no significant weight change due to oxidization. These results show that among compounds having the apatite-type crystalline structure, those containing Ce have the oxygen storage ability.

From FIG. 9 and Table 1, it was confirmed that the products of Examples 13 to 15 containing Eu showed a significant weight change due to oxidation and had the oxygen storage ability. In addition, the products of Examples 13 to 15 containing Eu exhibited a large oxygen storage amount compared with those of Examples 1 to 2 containing Ce.

It is originally known that apatite containing Ce(Ce³⁺) does not exhibit the oxygen storage amount expected when all Ce³⁺ is oxidized to Ce⁴⁺, that is, not all Ce³⁺ contained in the structure is oxidized to Ce⁴⁺. On the other hand, it is considered that in apatite containing Eu²⁺, which is more easily oxidized than Ce³⁺, Eu²⁺ is easily oxidized to Eu³⁺ and more oxygen (O₂) can be incorporated into the structure.

2-5. Discussion on Oxygen Storage Mechanism (Relationship between Crystalline Structure and Oxygen Storage Ability)

FIG. 1 shows the crystalline structure of apatite-type (Ce_{9.33}Si₆O₂₆). Compounds containing rare earth metals such as La and having an apatite-type crystalline structure have been studied as oxide ion (O²⁻) conductors in, for example, J. E. H. Sansom et al., Solid State Ionics, 139, 205-210 (2001), “A powder neutron diffraction study of the oxide-ion-conducting apatite-type phases, La_{9.33}Si₆O₂₆ and La₈Sr₂Si₆O₂₆”, and Y. Masubuchi et al., Solid State Ionics, 166, 213-217 (2004), “Oxide ion conduction in Nd_{9.33}(SiO₄)₆O₂ and Sr₂Nd₈(SiO₄)₆O₂ single crystals grown by floating zone method.” As illustrated in FIG. 1, the apatite-type crystalline structure has an O²⁻ conduction path and is surrounded by rare earth metal sites. When the rare earth metal is Ce (such as Ce_{9.33}Si₆O₂₆), the oxidation of compounds in the atmosphere or under an oxidizing atmosphere turns Ce³⁺ into Ce⁴⁺ and reduces the ionic radii of the rare earth metal sites surrounding the O²⁻ conduction path. It is considered that this results in an expansion of the O²⁻ conduction path, thereby functioning as an O²⁻ storage space.

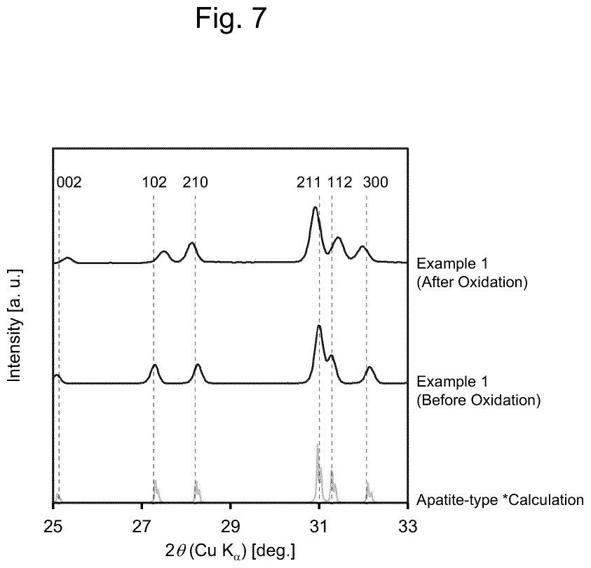

FIG. 7 shows the X-ray diffraction diagram of the product of Example 1 before and after oxidation, and Table 2 shows a lattice constant and a volume of a unit cell of the product of Example 1.

TABLE 2
Lattice Constant and Volume of Unit Cell of Product
of Example 1 before and after Oxidation

| | Lattice Constant | Lattice Constant | Volume of |
|---|---|---|---|
| | in a- and b-axis | in c-axis | Unit Cell |
| | Direction [nm] | Direction (nm) | [nm³] |
| Before Oxidation | 0.9700 | 0.7038 | 0.5735 |
| After Oxidation | 0.9653 | 0.7104 | 0.5733 |
| Amount of Change | −0.48% | 0.94% | −0.04% |

According to Table 2, although incorporating oxygen into the crystalline structure by oxidation (oxygen storage) increases the weight and increases the number of atoms per unit cell, the volume of the unit cell remains almost unchanged. This is because Ce changes from Ce³⁺ to Ce⁴⁺ by oxidization, and at the same time, O²⁻ is inserted. It is considered that the unit cell expands in the a-axis and b-axis directions by being pushed apart by O²⁻, but slightly contracts in the c-axis direction since Ce³⁺ becomes Ce⁴⁺, resulting in a very small change in the volume of the unit cell.

2-6. Explanation for Fact that Apatite Containing Eu(Eu²⁺) is Superior to Apatite Containing Ce(Ce³⁺) in Oxygen Storage Amount

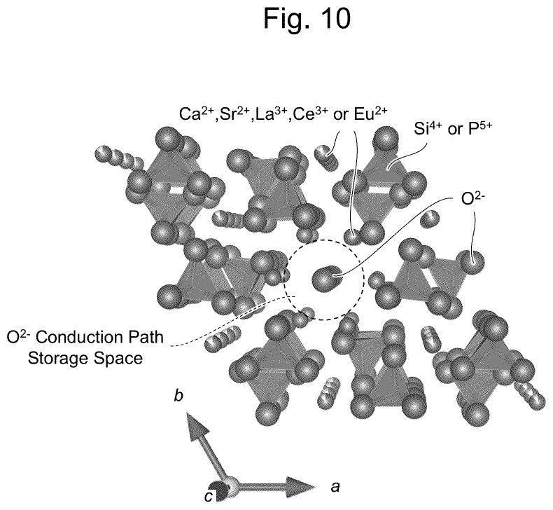

The apatite of the present disclosure is synthesized in a reducing atmosphere, and Ce is contained as Ce³⁺ and Eu is contained as Eu²⁺. Since the standard electrode potentials of ions are 1.61 eV for Ce³⁺→Ce⁴⁺+e⁻ and −0.35 eV for Eu²⁺→Eu³⁺+e⁻, it is considered that, as an ion, Eu²⁺ is more easily oxidized and more easily stores oxygen than Ce³⁺. In the crystalline structure, Ce³⁺ and Eu²⁺ occupy the same site, but have different valences, making it difficult to carry out an experiment in which elements other than Ce or Eu and amounts thereof are completely equalized. However, charge compensation can be performed without affecting the oxygen storage amount using ions with a valence that does not change. FIG. 10 illustrates sites occupied by Ce³⁺ and Eu²⁺, and Ca²⁺, Sr²⁺, and La³⁺, which are ions with valences that do not change, and sites occupied by Si⁴⁺ and P⁵⁺.

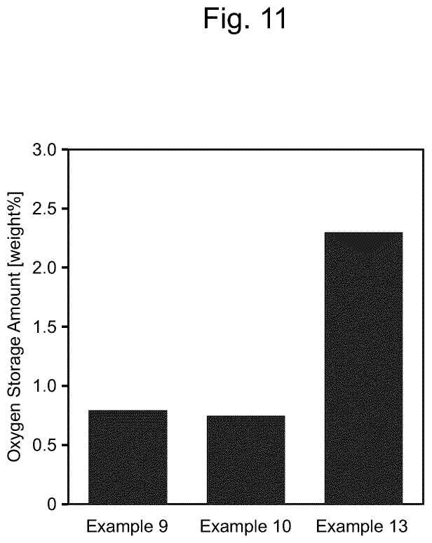

For example, while Example 9 (Ce₈Ca₂Si₆O₂₆) and Example 10 (Ce₈Sr₂Si₆O₂₆) are slightly different from Example 13 (Eu₈La₂P₆O₂₆) in elements other than Ce or Eu and amounts thereof, those skilled in the art would recognize that this is for charge compensation, which does not affect the oxygen storage amount, and is the effect of substituting Ce with Eu. Next, the composition, the proportions of Ce and Eu, and the oxygen storage amount of Examples 9 to 10 and 13 are shown in Tables 3 and FIG. 11.

TABLE 3
Composition, Proportions of Ce and Eu, and Oxygen Storage Amount of Examples 9 to 10 and 13

| | Proportion of Ce to Total | Proportion of Eu to Total | Atmospheric | Composition after |
|---|---|---|---|---|
| Composition | Amount-of-substance of A | Amount-of-substance of A | Oxidation | Oxidation |
| A₁₀T [symbol] O₂ [symbol] | [mol %] | [mol %] | OSC [weight %] | A₁₀T [symbol] O₂ [symbol] ₊ [symbol] |
| Ce [symbol] Ca₂Si₆O₂₆ | 80 | 0 | 0.80 | Ce [symbol] Ca₂Si₆O_{26+0.9} |
| Ce [symbol] Sr₂Si₆O₂₆ | 80 | 0 | 0.75 | Ce [symbol] Sr₂Si₆O_{26+0.9} |
| Eu [symbol] La₂P [symbol] O₂₆ | 0 | 80 | 2.31 | Eu [symbol] La₂P [symbol] O_{26+3.0} |

[symbol]

indicates data missing or illegible when filed

From Table 3 and FIG. 11, it was found that, when the composition of apatite of the present disclosure is represented by A₁₀T₆O₂₆, Example 13, in which 80 mol % of A is Eu²⁺, exhibited a greater oxygen storage amount than Example 9 and Example 10, in which 80 mol % of A is Ce³⁺. The results also show that apatite containing europium (Eu) as a main component has a greater oxygen storage amount than apatite containing cerium (Ce) as a main component.

All publications, patents and patent applications cited in the present description are herein incorporated by reference as they are.

What is claimed is:

1. An oxygen storage material comprising
a composite oxide,
wherein the composite oxide contains cerium and/or europium and silicon and/or phosphorus,
wherein the composite oxide has an apatite-type crystalline structure.

2. The oxygen storage material according to claim 1,
wherein the composite oxide is represented by the following general formula: A_{α}T_{β}X_{γ} (In the formula, A includes cerium and/or europium; T includes silicon and/or phosphorus; X includes oxygen; α, β, and γ each represent a mole ratio; and α is 9.33 to 10, β is 6, and γ is 24 to 30.).

3. The oxygen storage material according to claim 2,
wherein A includes cerium.

4. The oxygen storage material according to claim 2,
wherein A includes europium.

5. The oxygen storage material according to claim 2,
wherein a content of cerium and/or europium is 20 mol % or more relative to a total amount-of-substance of A,
wherein A further includes one or more elements selected from the group consisting of calcium, strontium, yttrium, lanthanum, praseodymium, samarium, ytterbium, and lutetium.

6. The oxygen storage material according to claim 2,
wherein T further includes boron.

7. The oxygen storage material according to claim 1, further comprising
a catalyst metal,
wherein the catalyst metal is supported on the composite oxide.
